(19) United States
(12) Patent Application Publication
(10) Pub. No.: US 2006/0165081 A1
(43) Pub. Date: Jul. 27, 2006

(54) Deflection-routing and scheduling in a crossbar switch

(75) Inventors: Alan F. Benner, Poughkeepsie, NY (US); Casimer M. DeCusatis, Poughkeepsie, NY (US)

Correspondence Address: CANTOR COLBURN LLP-IBM POUGHKEEPSIE, 55 GRIFFIN ROAD SOUTH, BLOOMFIELD, CT, 06002, US

(73) Assignee: International Business Machines Corporation, Armonk, NY (US)

(21) Appl. No.: 11/041,333

(22) Filed: Jan. 24, 2005

(51) Int. Cl. H04L 12/66; H04L 12/56

(52) U.S. Cl. 370/390; 370/392; 370/432

(57) ABSTRACT

An apparatus, method, and system may be provided for contention resolution in data transfer in a crossbar switch. The method may comprise sending data through a crossbar switch; routing deflected data to a deflection port wherein deflected data is data which unsuccessfully contends for a requested port; and sending the deflected data from the deflection port to the requested port. A deflection port may be a port which may be guaranteed to be at least temporarily idle.

### BACKGROUND OF THE INVENTION

Crossbar data switches are widely used in interconnect networks such as LANs, SANs, data center server clusters, and internetworking routers, and are subject to steadily-increasing requirements in speed, scalability and reliability. Crossbar switches are distinguished from packet switches by their lack of internal buffering. At any particular time, the data streams at each input are routed to one of the outputs, with the restriction that, at all times, due to the lack of buffering capability, each input transmits to at most one output, and each output receives data from at most one input. This function can be referred to as “data switching”. Crossbar data switches typically are accompanied by a centralized scheduler that coordinates the data transmission and creates a switch schedule at one central point. However, if a centralized scheduling point fails, the entire crossbar switch becomes disabled. Additionally, a centralized scheduler is not readily scalable to handle additional servers or line cards for example. Latency or time delays caused by the round trip of scheduling the data transmission between the centralized scheduler and the servers or line cards also can cause bottlenecks. Thus a fast, scalable, reliable and flexible scheduler system is needed.

### BRIEF SUMMARY OF THE INVENTION

The present contention resolution method for data transmission through a crossbar switch may comprise sending data through a crossbar switch; routing the deflected data to a deflection port wherein the deflected data unsuccessfully contends for a requested port; and sending the deflected data from the deflection port to the requested port. The present apparatus for controlling conflict resolution of data transmission through a data crossbar switch may comprise a plurality of line cards for sending data through a crossbar switch; and at least one deflection port located in the plurality of line cards wherein the deflection port is structured to receive the deflected data which unsuccessfully contends for a requested port. The present system may comprise a means for sending data through a crossbar switch; a means for routing deflected data to a deflection port wherein the deflected data unsuccessfully contends for a requested port; and a means for sending the deflected data from the deflection port to the requested port. One or more computer-readable media having computer-readable instructions thereon which, when executed by a computer, may cause the computer to send data through a crossbar switch; to route the deflected data to a deflection port wherein the deflected data unsuccessfully contends for a requested port; and to send the deflected data from the deflection port to the requested port.

### BRIEF DESCRIPTION OF THE DRAWINGS

Embodiments will now be described, by way of example only, with reference to the accompanying drawings which are meant to be exemplary, not limiting, and wherein like elements are numbered alike in several Figures, in which:

FIG. 1 illustrates a prior art crossbar switch system using a centralized scheduler.

FIG. 2 illustrates a variation on the prior art using centralized scheduling with redundant components.

FIG. 3 illustrates the distributed scheduling approach of an exemplary embodiment.

FIG. 4 illustrates contention for the same port in a crossbar switch environment of an exemplary embodiment.

FIG. 5 illustrates re-routing of data once a port becomes available in a switch.

FIG. 6 illustrates the broadcasting of priority requests to all cards in a crossbar switch.

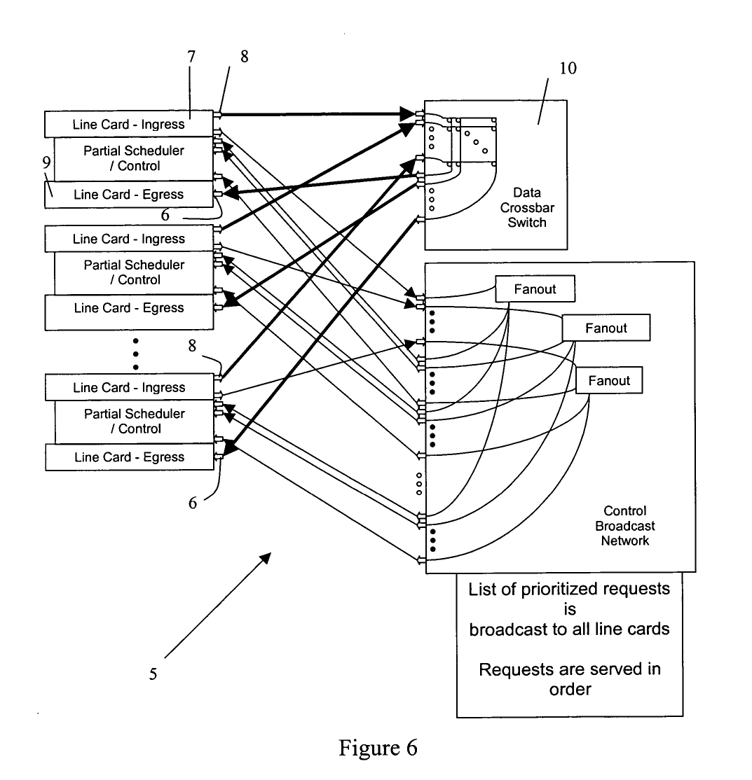

FIG. 7 is a flow chart of an algorithm for quality of service aware deflection routing.

### DETAILED DESCRIPTION OF THE PREFERRED EMBODIMENT

This disclosure may be applied to high performance servers and clustered superscalar computing or InfiniBand applications for example. For example, at present, there are efforts to accelerate the development of high speed optical technology aimed at significantly increasing network bandwidth while reducing the cost of supercomputers, all of which are attributes required to surpass electronic interconnect technologies. These efforts endeavor to address a persistent challenge in the design of high-performance computer systems which is to match advances in microprocessor performance with advances in data transfer performance. US government agencies and firms in the IT industry anticipate a point when scaling supercomputer systems to thousands of nodes with interconnect bandwidth of tens of gigabytes per second per node will require the use of optically switched interconnects, or other advanced interconnects, to replace traditional copper cables and silicon-based switches.

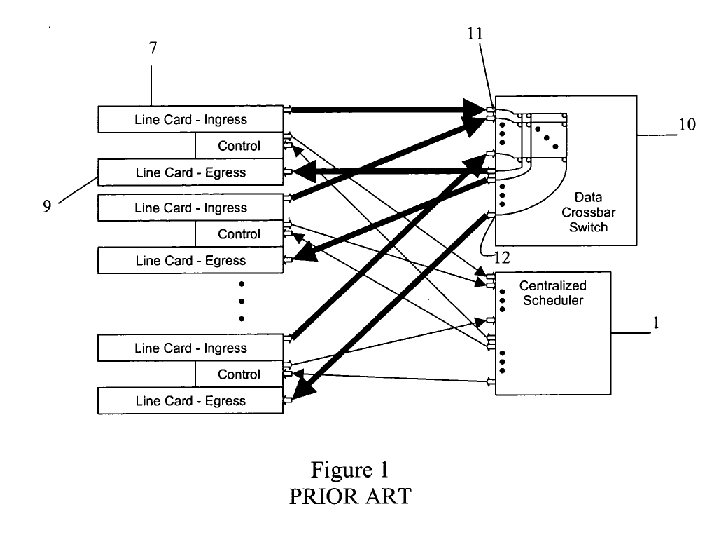

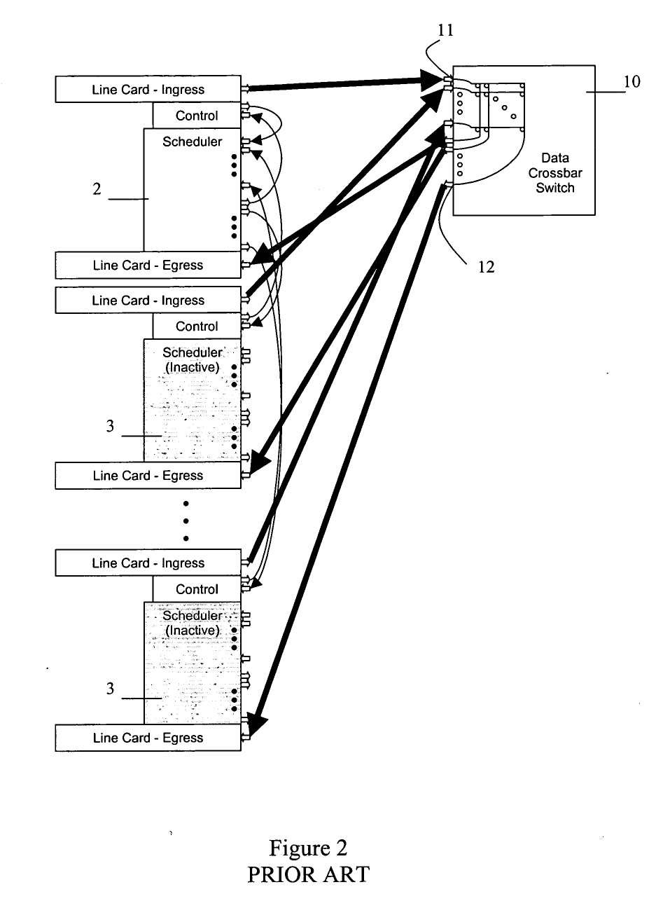

As shown in Prior Art FIGS. 1 and 2 for example, data crossbar switches 10 such as those used in server clustering applications are distinguished from packet switches by their lack of internal buffering. At any particular time, data streams at each input ports 11 are routed to one of the output ports 12, with the restriction that, at all times, due to the lack of buffering capability, each input transmits to at most one output, and each output receives from at most one input. This function can be referred to as “data switching”.

Crossbar data switches 10 may be implemented using a variety of technologies. Some examples include: an electronic switch using standard CMOS or bipolar transistor technology implemented in silicon or other semiconductor material; an electronic switch using superconducting material; an optical switch using beam-steering on multiple input beams, or an optical switch using tunable input lasers in conjunction with a diffraction grating or an array waveguide grating, which diffract different wavelengths of light to different output ports. Additionally, a variety of other technologies may be used for implementing the function of crossbar data switching and the list above is not limiting in this regard. The invention described here applies to scheduling for any type of crossbar switch technology. It is noted that crossbar data switches 10 implemented with optical switching technology are described below as an exemplary embodiment; however all forms of crossbar switches are encompassed within the scope of the present invention as well centralized or decentralized schedulers.

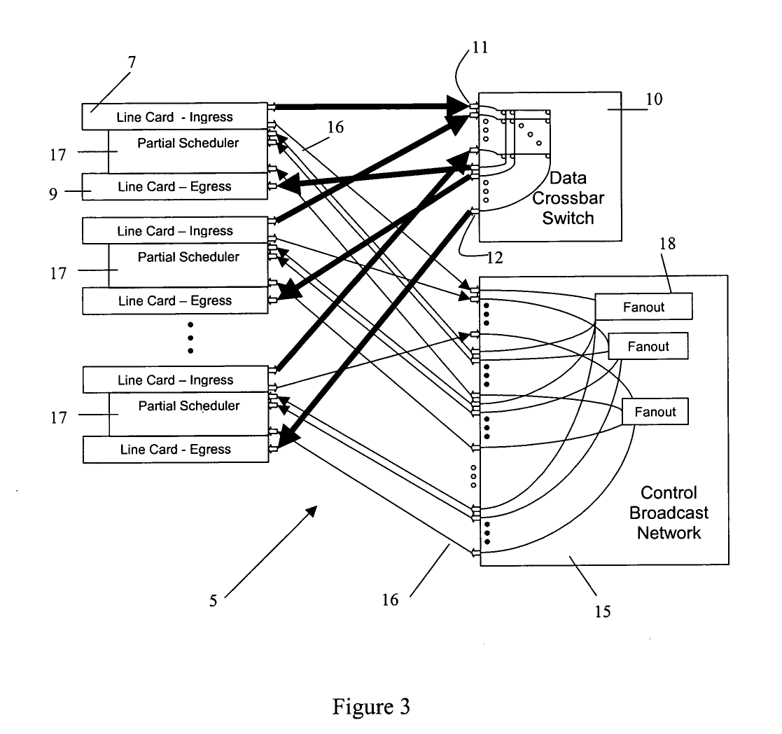

Referring to FIG. 3, since an overall switch fabric 5 typically requires other functionality besides bufferless data switching, a switch fabric 5 will typically include line card ingress 7 and line card egress 9 elements, along with the data crossbar switch 10. These line cards (7,9) are typically implemented as separate components to the data crossbar switch 10, and may be located on different cards, but could functionally be part of the same package. For example, the specific structure shown in the figures should not be construed as limiting to the present invention. The line cards (7,9) may implement other functions, such as flow control, or header parsing to determine data routing, or data buffering.

Since a data crossbar switch 10 has no buffering, and requires non-overlapping input port 11 and output port 12 scheduling, a crossbar scheduling function is typically used. The typical existing implementation of this scheduling function is shown in prior art FIG. 1. This figure shows the data crossbar switch 10, the line cards (7,9) each with ingress and egress halves, and a shared centralized scheduler 1 mechanism. One disadvantage of the topology shown in FIG. 1 is the requirement for a separate and distinct centralized scheduler 1 unit, which must be constructed in addition to the line card units (7,9). A further disadvantage is that the centralized scheduler 1 is a single-point of failure in the system, such that if the scheduler is disabled through some means, the overall switch will not operate. A possible alternative is shown in prior art FIG. 2. In FIG. 2, the scheduling function is implemented inside the line cards in an associated scheduler 2. In normal operation, only one instance of the scheduler 2 would be activated, while the others are disabled or held in reserve. One of the disabled schedulers 3 can be enabled if there is a problem with scheduler 2. However, this approach still requires a single working scheduler 2 to run the entire switch, which continues to be a potential scalability bottleneck and potential single point of failure.

In normal operation of the prior art system, as shown in FIGS. 1 and 2 with a centralized scheduler 1, each of the input line cards 7 sends information to the centralized scheduler 1 on a frequent basis about the data that it has queued and requesting connection to one or more of the outputs for data routing. The scheduler 2 functions are to: receive connection request information from each input line card 7, determine, using one of a number of existing algorithms, an optimized cross bar schedule (not shown) for connecting inputs 11 of the data crossbar switch 10 to outputs 12 of the data crossbar switch 10 through the data crossbar switch 10, and then communicate the cross bar schedule (not shown) to the line cards 7,9 to send the transmission data, i.e., the centralized scheduler 1 which is one point is in active control of the entire scheduling process.

In contrast to the prior art discussed above, the present disclosure provides a mechanism for crossbar switch 10 scheduling which provides improved performance, better reliability, and lower expense by eliminating the centralized scheduler 1 which is a single point of failure.

In an embodiment, a scheduling function is distributed across each of the line cards (7,9) in parallel by using partial schedulers 17 implemented with each line card (7, 9). Thus, the centralized scheduler 2 is replaced with a simpler control broadcast network 15, which distributes the traffic control information 16 to each partial scheduler 17, as shown in FIG. 3. The control broadcast network 15 is not as complicated or expensive as the prior art centralized scheduler unit 1 because it merely has to relay the traffic control information 16 to each partial scheduler 17. An example of this splitting or replicating of the control information 16, so that it can be sent to all of the partial schedulers 17, is shown by the “fan out” 18 operation as shown in FIG. 3. In an all-optical system for example, this fan out 18 may be accomplished by an optical beam splitter. In a hybrid or electrical scheduler system for example, a simple electrical device can be used as the control broadcast network 15 to replicate or split the control information signal 16. The control broadcast network 15 may therefore be a completely passive device. Thus, the simplicity of the control broadcast network 15 improves reliability as compared to the active and more complex centralized scheduler 1 of the prior art. It is also less expensive to use the control broadcast network for this reason as well.

FIG. 3 shows the partial schedulers 17 implemented at each line card (7,9), where each partial scheduler uses the control information 16 distributed across the control broadcast network 15. Thus, instead of using a central switch scheduler 2 as shown in the prior art at FIGS. 1 and 2, an embodiment of the present invention places the scheduling logic in partial schedulers 17 associated with each line card (7,9), and implements a control broadcast network 15 to distribute the control information 16. All line cards (7,9) perform the overall scheduling in parallel, i.e., using parallel processing, and each line card (7,9) calculates its own portion of what to send and receive based on the control information 16 which has been aggregated together or replicated or split by the control broadcast network 15. For example, in an exemplary embodiment as shown in FIG. 3, the operation is as follows. Each input line card 7 transmits to the control broadcast network 15 the control information 16 necessary for determining appropriate schedules. This information may include status of ingress queues, ingress traffic prioritization, as well as egress buffer availability on the egress portions of the line cards as is known for standard protocols such as SONET, InfiniBand or other protocols. For example, a 1 Tx/N RX structure may be used for the line cards. The control information 16 from the input line cards is replicated in the Control Broadcast Network 15, and distributed to all of the line cards (7,9). The partial scheduler 17 in each line card determines the portion of the overall schedule which applies directly to the line card doing the scheduling, i.e., based on the control information 16 that has been now been sent to all of the partial schedulers 19 from the control broadcast network 15, in other words, the split, replicated and/or aggregated control information. Once all partial schedules (not shown) have been calculated, separately for each line card (7,9), all line cards (7,9) send data through the Data Crossbar switch to/from their ingress sections to their scheduled output ports. This process of steps is repeated at regular intervals, as data arrives at the ingress sections of the line cards 7 to be switched through the full switch fabric 5.

Since the line cards (7,9) all use the same algorithm for scheduling, and the same broadcast control information 16, they are assured that their partial schedules will each be consistent parts of a overall global crossbar schedule, and there will not be contention at the output ports 12 of the crossbar switch 10.

This requires multiple partial schedulers 17 and broadcast of the aggregated control information 16 to all line cards, rather than using a single centralized scheduler 1 to actively coordinate all incoming and outgoing data traffic. While this does require some modification to the circuit design, this is more than offset by the advantages of this design, especially for optical implementations of crossbar switching. Advantages of this invention include, but are not limited to, the following:

1. Fully-Symmetric Reliability and Failover Protection: The present distributed scheduler system has much better redundancy characteristics than the prior art as shown in FIGS. 1 and 2, since failure of one partial scheduler 17 allows all other line cards (7,9) to continue operation through the crossbar switch 10. The prior art centralized scheduling method has a single point of failure for the full crossbar switch 10, since failure of the centralized scheduler 1 causes failure of the full crossbar switch 10. It is important to note that the “Fanout” 18 functions within the Control Broadcast Network 15 may be completely passive in the embodiment described above, and therefore not subject to failure.

As shown in FIG. 2, it would be possible to achieve a measure of system redundancy with the prior art centralized scheduler 1 by implementing two or more centralized schedulers (1,3) and incorporating failover mechanisms to use one centralized scheduler 1 or the another if the centralized scheduler fails. However, the present disclosed embodiments above have better performance and failover characteristics, since each operational line card (7,9) does not have to change configurations if a different line card fails and since the whole cross bar data switch 10 does not stop working for a time when the, first centralized scheduler 1 fails and another centralized scheduler 3 is configured to run.

2. Lower Control Delay: The present distributed scheduler system also allows each input to transmit after it completes only two steps, namely (1) aggregation or providing al of the of traffic control information 16 at the partial schedulers 17, and (2) parallel processing or execution of the scheduling algorithm in the partial scheduler 17. The existing art method with a centralized scheduler 1 requires a further step of (3) broadcasting of the actively calculated global schedule to all line cards from the centralized scheduler 1.

3. Better Reliability through Reduced Complexity: The present distributed scheduler system is less complex than a centralized scheduler 1 as shown in the prior art and can more easily constructed using a single type of part since all line cards (7,9) are substantially identical. The prior art required a separate centralized scheduler 1, which would be substantially different than a line card and due to its complexity it would be more prone to failure than the present system. Thus, the present system provides better reliability; and eliminates the single point of failure associated with a central scheduler. The present distributed scheduler system continues operation if any particular line card (7,9) fails. Also the present distributed scheduler system may use a passive control broadcast network which should also be inherently more reliable than a complex and actively controlled centralized scheduler unit 1.

4. Simpler Scheduler Logic: Since each line card (7,9) only has to calculate a partial schedule (i.e., the part of a global schedule for which it is responsible to transmit and receive data through the data crossbar switch 10), the implementation of each partial scheduler 17 can be somewhat simpler than the implementation of the complete centralized global scheduler. Thus, it is noted that the present distributed system operates independently of the algorithm used for scheduling the crossbar switch which may be one of many known algorithms for SONET, INFINIBAND or other protocols.

The basic architecture for the system described above is shown in FIG. 3 and has been termed an RDR “Replicated Distributed Responseless” system by the inventors herein. Previously, it was assumed that the scheduling algorithms running in parallel at each port would include some form of contention resolution, for example in case two ingress ports 8 requested access to the same egress port 6 at the same time. In a conventional switch, this function would be handled by a centralized scheduler 1. In the present distributed scheduler system using a control broadcast network 15 instead, however, there is no central point of control to arbitrate between two contending ingress ports 8. Thus, in this disclosure, one method for contention resolution is proposed and described and termed herein as “deflection routing.” However, it is noted that the present deflection routing may also be used with a centralized scheduler.

Another concern is that the prior art centralized scheduler 1 is able to enforce quality of service and prioritization requests; and this function may not be as straightforward for a distributed scheduler. In this disclosure, a system and method is proposed for optimizing priority of service on a data crossbar switch 10, which is especially well suited to applications with long round trip times on the control signal path.

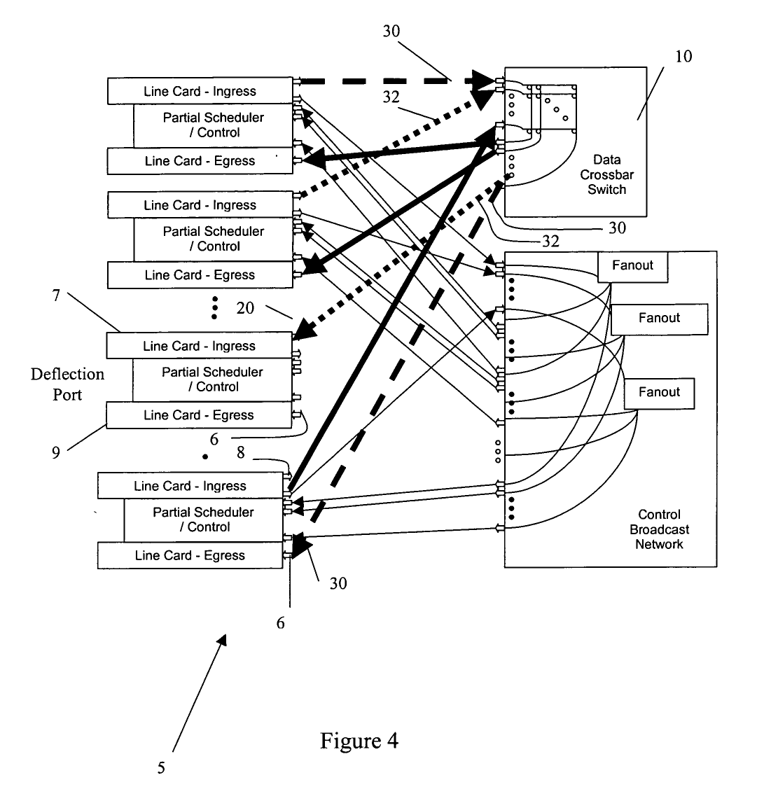

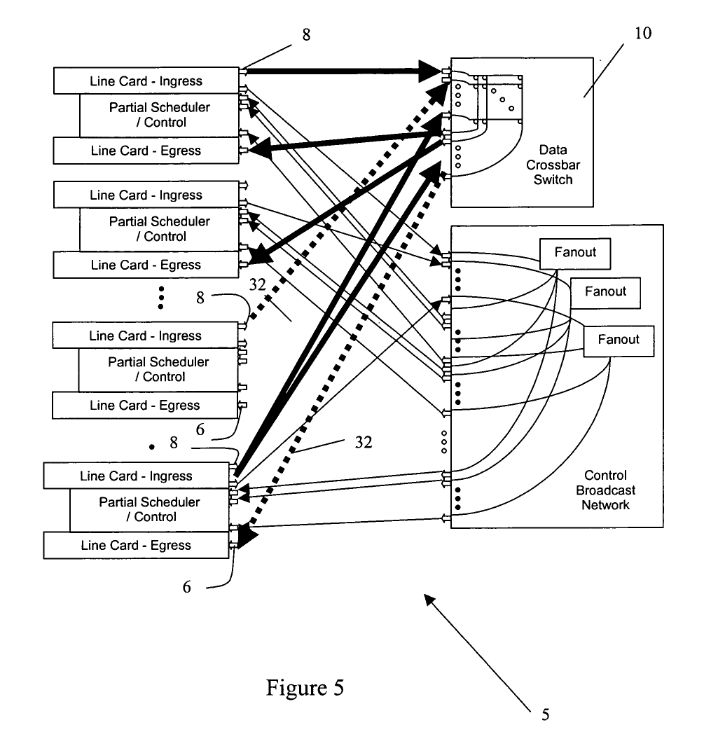

As shown in FIG. 4, the present application introduces the concept of a deflection port 20. For example, the deflection port 20 may be an unused port on a line card 7 which has no ingress or egress and which can be used if contention arises. Also for example, as shown by the arrows (30, 32) in FIG. 4, if there is contention for access to a requested port for example, egress port 6 on any desired line card, the crossbar data switch 10 transfers data, which may be in packet form or other form for example, to the deflection port 20 where it is held until the requested port is available, for example one-processing cycle, at which time the data which may be stored in a buffer at the line cards (7,9) and which is termed herein “deflected data” 32 is routed from the deflection port 20 back to the originally requested port 6 as shown by the arrows in FIG. 5. It is further noted that if the data or data packets are distinguished by arrival time, then proper ordering can be maintained even if deflection causes temporary mis-ordering.

Thus, implementation of a deflection port 20 offers several advantages. For example, this solution also allows non-congested or non-contentious traffic to continue passing through the switch fabric 5 unaffected by the contention request. This solution optimizes overall switch throughput, since it distributes traffic among the available switch ports. Thus, unused memory and port bandwidth resources are used to distribute traffic more smoothly in the rest of the switch.

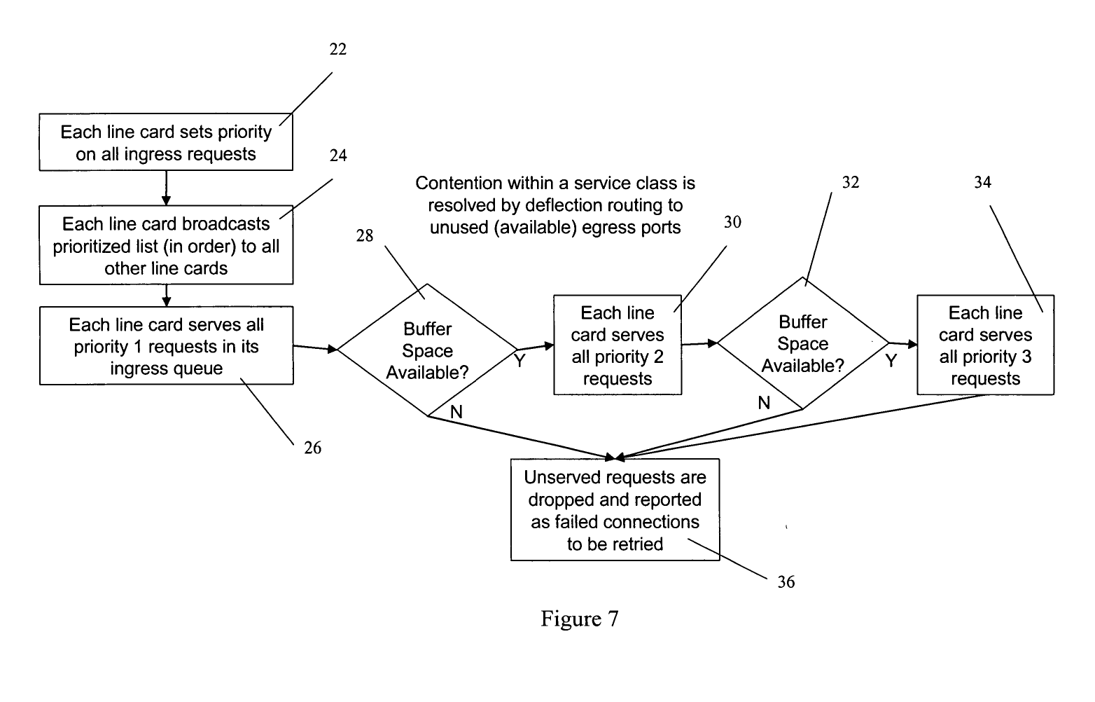

As shown in FIG. 7, an algorithm is presented which can be followed by the distributed system discussed above or in the centralized switch as in the prior art. The algorithm provides quality of service, particularly in a switch architecture with a long round trip delay on a control path. Thus, as shown in FIG. 7, it is further proposed herein that each source, for example line card 7 or requesting ingress port 8 may establish or set its individual priority of ingress requests 22 then broadcast the prioritized list, in prioritized order, to all the other ports 8 or line cards (7,9). This may be done through the control broadcast network 15 for example. Each of the ports or line cards (7, 9) then take all “priority 1” requests and service them first 26, then, if there is sufficient buffer space available 28 and no contentions, the ports serve all remaining “Priority 2” requests 30, and so on. Thus, if buffer space is available 28,32, all “Priority 2” 30 and or “Priority 3” 34 requests are served. Any unserved requests are dropped and reported as failed connections to be retried 36.

It is also possible to combine the above algorithm with use of a deflection port 20. When combined with deflection routing, this method assures that all requests will be served in the correct priority order.

It is also noted that deflection routing works seamlessly with a logically partitioned switch. There is a further advantage that when a partitioned switch is not making use of all the available ports in a logical partition; one or more unused ports outside the partition may be defined as the deflection ports 20, thus allowing the remaining partition to operate at maximum capacity (in this case, deflection routing does not need to wait for unused resources elsewhere in the partition, instead it can use resources outside the partition). It is noted that overall performance under partitioning depends on the logical structure of the switch partitions.

Another advantage of this approach occurs when a logically partitioned switch requires quality of service or prioritized requests. Consider the case when a switch must service a larger than expected number of priority 1 requests, and may not have resources for lower priority traffic. In this case, the present system can invoke the distributed scheduler system using in a variety of ways to alleviate the workload. For example, lower priority traffic may be directed to another logical partition (prioritization may then be used to filter traffic among different partitions; for example to distinguish between inter-switch and switch-to-node traffic partitions). The logical partition may also be re-configured on the fly, allocating more line cards to handle higher priority traffic and then removing them once again when traffic subsides.

The capabilities of the present invention may be implemented in hardware, software, or some combination thereof.

As one example, one or more aspects of the present invention can be included in an article of manufacture (e.g., one or more computer program products) having, for instance, computer usable media. The media may have embodied therein, for instance, computer readable program code means for providing and facilitating the capabilities of the present invention. The article of manufacture can be included as a part of a computer system or sold separately.

Additionally, at least one program storage device readable by a machine, tangibly embodying at least one program of instructions executable by the machine to perform the capabilities of the present invention can be provided.

The figures depicted herein are just examples. There may be many variations to these diagrams or the steps (or operations) described therein without departing from the spirit of the invention. For instance, the steps may be performed in a differing order, or steps may be added, deleted or modified. All of these variations are considered a part of the claimed invention.

While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims. Moreover, the use of the terms first, second, etc. do not denote any order or importance, but rather the terms first, second, etc. are used to distinguish one element from another.

1. A contention resolution method for data transmission through a crossbar switch comprising:
sending data through a crossbar switch;
routing deflected data to a deflection port wherein deflected data is data which unsuccessfully contends for a requested port; and
sending the deflected data from the deflection port to the requested port.

2. The method of claim 1 further comprising:
prioritizing the data before sending the data through the crossbar switch by assigning a priority level to the data; and
selecting the data to be the deflected data according to the priority level.

3. The method of claim 1 wherein prior to sending the data through the crossbar switch the following occurs:
scheduling a data transmission schedule so that each line card may send data through the crossbar switch.

4. The method of claim 1 wherein prior to sending the data through the crossbar switch the following occurs:
sending data transfer control information from a plurality of line cards to a control broadcast network;
sending the data transfer control information from the control broadcast network to a plurality of partial schedulers; and
scheduling from the data transfer control information a data transmission schedule in each partial scheduler so that each line card may send data through the crossbar switch.

5. The method of claim 4 wherein the control broadcast network passively sends the data transfer control information to the plurality of partial schedulers.

6. The method 4 wherein the control broadcast network optically splits the data control information when sending the data transfer control information from the control broadcast network to the plurality of partial schedulers.

7. The method 4 wherein the control broadcast network fans out the data control information when sending the data transfer control information from the control broadcast network to the plurality of partial schedulers.

8. The method 4 wherein the control broadcast network aggregates and replicates the data control information when sending the data transfer control information from the control broadcast network to the plurality of partial schedulers.

9. An apparatus for controlling conflict resolution of data transmission through a data crossbar switch comprising:
a plurality of line cards for sending data through a crossbar switch; and
at least one deflection port located in the plurality of line cards;
wherein the deflection port is structured to receive deflected data wherein deflected data is data which unsuccessfully contends for a requested port.

10. The apparatus of claim 9 further comprising:
a plurality of partial schedulers for the line cards; and
a control broadcast network;
wherein the partial schedulers are structured to receive control information from the line cards via the control broadcast network and to create a schedule from the control information for transmitting data through the crossbar switch.

11. The apparatus of claim 10 wherein the control broadcast network is structured as a passive device.

12. The apparatus of claim 10 wherein the control broadcast network is structured as an optical splitter.

13. The apparatus of claim 10 wherein the control broadcast network is structured to aggregate and replicate the control information in order to send the control information from the control broadcast network to the partial schedulers.

14. A system comprising:
means for sending data through a crossbar switch;
means for routing deflected data to a deflection port wherein deflected data is data which unsuccessfully contends for a requested port; and
means for sending the deflected data from the deflection port to the requested port.

15. The system of claim 14 further comprising:
means for prioritizing the data before sending the data through the crossbar switch by assigning a priority level to the data; and
means for selecting the data to be the deflected data according to the priority level.

16. The system of claim 14 further comprising:
means for sending data transfer control information from a plurality of line cards to a control broadcast network;
means for sending the data transfer control information from the control broadcast network to a plurality of partial schedulers; and
means for scheduling from the data transfer control information a data transmission schedule in each partial scheduler so that each line card may send data through the crossbar switch.

17. One or more computer-readable media having computer-readable instructions thereon which, when executed by a computer, cause the computer to:
send data through a crossbar switch;
route deflected data to a deflection port wherein deflected data is data which unsuccessfully contends for a requested port; and
send the deflected data from the deflection port to the requested port.

18. The one or more computer-readable media of claim 17 further causing the computer to:
prioritize the data before sending the data through the crossbar switch by assigning a priority level to the data; and
select the data to be the deflected data according to the priority level.

19. The one or more computer-readable media of claim 17 further causing the computer to:
send data transfer control information from a plurality of line cards to a control broadcast network;
send the data transfer control information from the control broadcast network to a plurality of partial schedulers; and
schedule from the data transfer control information a data transmission schedule in each partial scheduler so that each line card may send data through the crossbar switch.

20. The one or more computer-readable media of claim 19, wherein the control broadcast network passively sends the data transfer control information to the plurality of partial schedulers.

21. The one or more computer-readable media of claim 19, wherein the control broadcast network optically splits the data control information when sending the data transfer control information from the control broadcast network to the plurality of partial schedulers.

22. The one or more computer-readable media of claim 19, wherein the control broadcast network fans out the data control information when sending the data transfer control information from the control broadcast network to the plurality of partial schedulers.

23. The one or more computer-readable media of claim 19, wherein the control broadcast network aggregates and replicates the data control information when sending the data transfer control information from the control broadcast network to the plurality of partial schedulers.
